(19) United States
(12) Patent Application Publication
(10) Pub. No.: US 2011/0008548 A1
(43) Pub. Date: Jan. 13, 2011

(54) PROCESS FOR MANUFACTURING CONDUCTIVE TRACKS

(76) Inventors: Patrick James Smith, Freiburg (DE); Josué Jean Philippe Valeton, Eindhoven (NL); Ko Hermans, Nederweet (NL)

Correspondence Address: HAMMER & ASSOCIATES, P.C., 3125 SPRINGBANK LANE, SUITE G, CHARLOTTE, NC, 28226, US

(21) Appl. No.: 12/808,702

(22) PCT Filed: Dec. 17, 2008
(86) PCT No.: PCT/EP08/67705

§ 371 Date: Jun. 17, 2010

(30) Foreign Application Priority Data
Dec. 20, 2007 (EP) 07024745.7
Oct. 14, 2008 (EP) 08166540.8

(51) Int. Cl. C08J 7/18; B05D 5/12

(52) U.S. Cl. 427/532; 427/126.1

(57) ABSTRACT

A process for manufacturing conductive tracks is disclosed comprising a coating step, in which an organometallic compound is applied from a solution onto a substrate; and a reducing step, characterized in that the reducing step is carried out by means of an acidic solution containing a reducing agent.

The invention pertains to a process for the manufacturing of conductive tracks, comprising a coating step, in which an organometallic compound is applied from a solution onto a substrate; and a reducing step. In the course of this invention said reducing step is also considered to be a development step, in which a conductive track or film is developed from a non-conductive track or film. Optionally, the organometallic compound can be activated by exposure to electromagnetic radiation prior to the reducing step.

Conductive tracks are currently used as one of the main components in a wide variety of applications ranging from electronic circuitry (e.g. in computers and displays), and antennas to anti-static films. These tracks are made from conductive metals (e.g. copper, silver or gold), ceramics (e.g. ITO) or polymers (e.g. poly(3,4-ethylenedioxythiophene)) and can be manufactured via different methods in a wide range of sizes and shapes.

A conventional method to create conductive tracks comprises the steps of depositing a conductive layer on a substrate by chemical or physical vapor deposition, for example. Next, a photosensitive coating is deposited on top of the conductive layer and the coating is locally exposed to light. During the local exposure a difference in solubility is created in exposed and non-exposed areas of the photosensitive layer and the soluble areas are subsequently removed using an appropriate solvent. In a following step, the conductive layer is exposed to an aggressive etching fluid and the parts, which are not shielded by the remaining photosensitive coating, are removed. In a final step, the remaining photosensitive coating is removed by using another solvent. Although this method can be used to create well-defined conductive tracks with small features on a large variety of substrates, the process is comprehensive and very expensive. Furthermore, most of the processing steps can only be applied batch-wise and the technique is not suitable for roll-to-roll processing.

To reduce the number of steps described in the previous process an alternative method is known from US 2003/207568, wherein a special organometallic compound as a photosensitive coating and a conductive metal precursor is disclosed. This compound is defined by the following formula MLL′X, where M is a metal, L is a neutral ligand, L′ is negatively charged ligand and X is an anion. Said compound is applied from solution to a substrate and locally exposed to light through a photolithographic mask to create conductive areas. In a final step, the non-exposed, non-conductive, areas are removed by exposing the material to a suitable solvent.

Another method is based on the concept of electroless plating. In this method, a substrate is exposed to several subsequent baths. First the substrate is etched and neutralized to ensure good adhesion and activated to ensure the absorption of a catalyst. Next it is exposed to a catalyst to promote the deposition of the conductive layer and exposed to an accelerator, which improves the deposition of the conductive layer. Finally the substrate is exposed to a solution of conductive material to create the conductive layer. This method can be used to create highly conductive tracks. However, the process is very complex and the solutions are often toxic and very aggressive. Furthermore, the method is very sensitive to the processing parameters and a slight deviation can result in spontaneous precipitation of the conductive material in non-desired areas.

A more convenient method to manufacture conductive tracks is based on the printing (e.g. ink-jet printing, offset printing, screen printing, or flexo printing) of conductive ink. These inks are usually made up from polymer solutions or nano-dispersions of colloidal metal particles. These methods have the advantage that the conductive tracks are created in the desired size and shape without any additional patterning steps. However, after applying the colloidal metal particles or polymers to the substrate a thermal treatment is required to make the applied materials conductive. In the case of the colloidal metal particles an organic coating, which is applied to the metal particles to form a stable dispersion, is removed and the particles are sintered together into densely packed conductive metal tracks. In the case of a polymer, the heat treatment is applied to remove any remaining solvent. These thermal treatments require relatively high temperatures (typically above 150° C.) for a long period of time (typically longer than 30 minutes). These techniques are therefore not suitable when applying conductive tracks on most common polymer substrates. As a result, only inorganic (e.g. glass or silicium) or expensive specialized polymer substrates (e.g. polyimide) can be used. Furthermore, the conductivity of conductive polymers is relatively poor compared to their inorganic counterparts.

It is therefore an objective of the invention to provide a low temperature, simple process to create conductive tracks on a large variety of substrates, and which process is compatible with the above-mentioned printing techniques. The conductive tracks, created by this process, exhibit very high conductivity and excellent mechanical properties.

According to the invention this object is achieved by a process described in the opening paragraph, wherein the reducing step is carried out by means of an acidic solution containing a reducing agent.

For the inventive process it is preferred that the temperatures in the course of the manufacturing process stay below 70 C.

A conductive track is to be understood as a pattern of a conductive material, which can be in any shape or size, with the restriction that the conductivity of the track should be more than 1000 Siemens per meter (S/m). Said track can cover the complete substrate on which it is deposited, but also only a part of it. Furthermore said track can be considered as a single feature or plurality of features.

In the course of this invention an organometallic compound is to be understood as any compound containing a direct or indirect chemical bond between a metal and carbon atom. This bond can have a covalent or an ionic character. Although a variety of metals are known to form an organometallic compound, for the invention the following metals either alone or in combination are preferred: copper, aluminum, platinum, palladium, silver or gold. The organic part of said compound should be large enough to allow sufficient dissolution in the preferred solvent. It should also be small enough not to have a limiting effect on the final properties of the conductive tracks. In a preferred embodiment of the invention the organometallic compound belongs to the class of metal carboxylates or metal thiolates, in which the number of carbon atoms lies between 4 and 20. In a more preferred embodiment of the invention the organometallic compound belongs to the class of metal carboxylates, in which the number of carbon atoms lies between 8 and 12, and in which the carbon backbone is branched. In an even more preferred embodiment of the invention the organometallic compound is a metal neodecanoate, most preferably silver neodecanoate.

In an alternative embodiment of the invention the film formation and/or the conductivity of the conductive tracks is improved by adding a solid organic compound to the organometallic solution. Said compound can be an oligomeric or polymeric component which can be dissolved in the same solvent as the organometallic compound. The molecular weight of said compound should be at least 500 gram/mol. Oligomers or polymers which can be used are known to those skilled in the art, and can for example be, but are not limited to: polycarbonate (PC,) polystyrene (PS), polymethylmethacrylate (PMMA), polyethylene (PE), polypropylene (PE) or poly(ethylene terephthalate) (PET). In another embodiment of the invention the solid organic compound is a polymeric precursor. The polymeric precursor should have at least one active group, which can react to other active groups with or without the addition of an initiator. Examples of these polymeric precursors are known to one skilled in the art and are understood to be any species, which can form a polymer or polymer network upon polymerization, such as, but not limited to, methylmethacrylate, ethylene, propylene or butadiene. The initiator is preferably a UV initiator, which is capable of reacting with the polymeric precursors upon absorption of UV light. In principle any known UV initiator can be used like for example any Irgacure® initiator of Ciba Specialty Chemicals in a typical concentration range of about 1 to 10 wt-%.

To apply the organometallic compound to a substrate it is dissolved in a suitable solvent. The organometallic compound should be sufficiently soluble in said solvent to allow the required adjustment of processing parameters, such as viscosity and surface tension, for a desired processing method. In a preferred embodiment of the invention the solvent is an organic, aromatic solvent like for example toluene or xylene. Although the solvent is evaporated after applying the organometallic compound to a substrate, it is also possible that residual solvent remains present the organometallic layer.

The organometallic compound can be applied from solution to the substrate via any known method, which can be used to apply thin layers from solution to a substrate. For the method of deposition such methods are preferred that allow the pattern of the intended conductive track to be deposited directly without the need for any additional patterning steps. Methods which can for example be used to apply the track in a desired pattern include ink-jet printing, solution casting, offset printing, screen printing, flexoprinting, spin coating, doctor blading, dip coating, capillary filling or spray coating.

The substrate on which the organometallic compound is applied can be polymeric, ceramic, glassy or metallic with the restriction that the substrate should not dissolve in the solutions containing the organometallic compound or reducing agent during the time said substrate is exposed to these solutions. Due to the low temperature manufacturing process of the conductive track it is possible to use flexible, commodity polymeric substrates such as poly(ethylene terephthalate) (PET) or comprising at least 80% of poly(ethylene terephthalate) and triacetyl cellulose (TAO) or comprising at least 80% of triacetyl cellulose, which tend to degrade and/or deform at elevated temperature. Due to the requirement of high temperature sintering, the use of convenient depositing techniques, such as inkjet printing, is not possible in the prior art.

The substrate on which the organometallic compound is applied can be any shape or size. The substrate can for example be a sheet, slide, foil, plate, fiber or a porous membrane.

In principle the conductivity can be achieved without exposure to electromagnetic radiation. On the other hand, the conductivity of such tracks or films is considerably lower compared to their irradiated counterparts. It is thus preferred to activate the organometallic compound by exposure to electromagnetic radiation. It is also found that this treatment results in significantly faster reducing times. Said exposure can be performed under ambient conditions or in any inert atmosphere without any significant change in the final properties of the conductive tracks. The electromagnetic irradiation is carried out by exposing to light as source having a wavelength range between 200-1000 nm, preferably between 250-450 nm. In a more preferred embodiment of the invention the light applied for the exposure is UV light.

The light source used in the examples is a high-pressure mercury vapor light source. The spectrum was used unfiltered and has (as is common with these type of lamps) a peak emission at 365 nm. The main part of this lamp emits between 250 and 450 nm.

It is preferred to use an exposure dose between 1 and 10 J/cm² of light with a wavelength between 320-390 nm. If a light source with a wavelength between 200 and 300 nm is used the exposure dose can be reduced to between 0.1 and 1 J/cm².

To those skilled in the art it is known that it is the exposure dose (intensity*time) which is “critical” and not only the intensity of the light source. Second, the required exposure dose depends on the absorption spectrum of the used organometallic compound. This means that higher energetic UV light (<300 nm) is usually more readily absorbed than less energetic UV light (300-400 nm).

Indeed daylight only may be sufficient to serve as an exposure step. If needed the required exposure dose and time can easily be determined by routine trials.

In an alternative embodiment only a part of organometallic compound is activated by locally exposing said compound to electromagnetic radiation. This can for example be done by using a photolithographic UV mask exposure or a holographic UV exposure. As a result of this patterned exposure a latent image is created in the organometallic film. This latent image is characterized by a difference in speed of reduction between the exposed and non-exposed areas. During the reducing step, the exposed areas are therefore more easily reduced into a conductive track than the non-exposed areas. It is preferred to remove the material remaining in the non-exposed areas by using a proper solvent such as for example toluene, xylene or isopropanol.

In a final step the layer comprising the organometallic and solid organic compound is exposed to an acidic solution containing a reducing agent. The solvent used for said solution should not dissolve or have any other detrimental effect on the substrate and/or the irradiated tracks on a relevant time scale (typically less than 5 minutes). In a preferred embodiment of the invention the solvent is water and/or an alcohol. The reducing agent, which is used to reduce the metal-ion to metal, should have the proper oxidation/reduction potential to effect reduction of the metal ion. The reducing agent and its oxidized derivative should be sufficiently soluble in the above-mentioned solvent composition to prevent any deposition of undesired residue of these chemicals onto the substrate and/or conductive tracks. They should also not have any detrimental effect on the used substrate on a relevant time scale (typically less than 5 minutes). In a preferred embodiment of the invention the reducing agent is a phenolic compound or a derivative thereof (such as hydroquinone, metol, p-aminophenol, pyrogallol, catechol, amidol) and/or ascorbic acid, formic acid, or boric acid. These substances can be applied either alone or in combination. In a more preferred embodiment of the invention the reducing agent is hydroquinone or a derivate thereof.

Preferably, the reducing agents are applied in a concentration in the order of 0.01 to 5 mol/liter and more preferably between 0.1 and 2 mol/liter.

If the reducing agent has acidic properties (hydroquinone or ascorbic acid), then it may be sufficient to simply dissolve this compound in a suitable solvent such as alcohol and/or water. Alternatively, the acidic character of the solution can be obtained by adding the appropriate amounts of sulphuric acid or sodium hydroxide to a solution of the reducing agent. It is found that the pH of the reducing solution is optimal between 2 and below 7, such as 6.9. In a preferred embodiment of the invention the pH of the reducing solution is between 2.5 and 6 and in an even more preferred embodiment the pH of the reducing solution is between 3 and 5.

In case of undiluted alcohols, this results in the formation of C2H5O— and H+ (forming C₂H₅OH₂+). The latter causes the potential difference, which is measured by the pH meter.

Additives can be used to prolong the useful lifetime of the reducing solution and/or shorten the reduction time. Examples of these are known to those skilled in the art, and can for example be, but are not limited to, sodium sulphite and sodium carbonate. Any method to bring a solution into contact with a substrate can be used for the reduction step, like for example dip coating and spray coating.

To ensure compatibility with substrates made of commodity plastics, such as PET, the entire process as described above can be carried out at low temperature, which is in general below 100° C. In a preferred embodiment of the invention the process is carried out between 0° C. and 70° C. In a more preferred embodiment of the invention the process is carried out between 15° C. and 40° C.

Surprisingly the conductive tracks, manufactured via the process according to this invention, were found to maintain their high conductivity under mechanical loading (both in bending and tensile testing). Therefore these tracks form an ideal combination with flexible substrates.

To elucidate—but by no means meant to limit the invention—some examples are given below.

Short description of the figures:

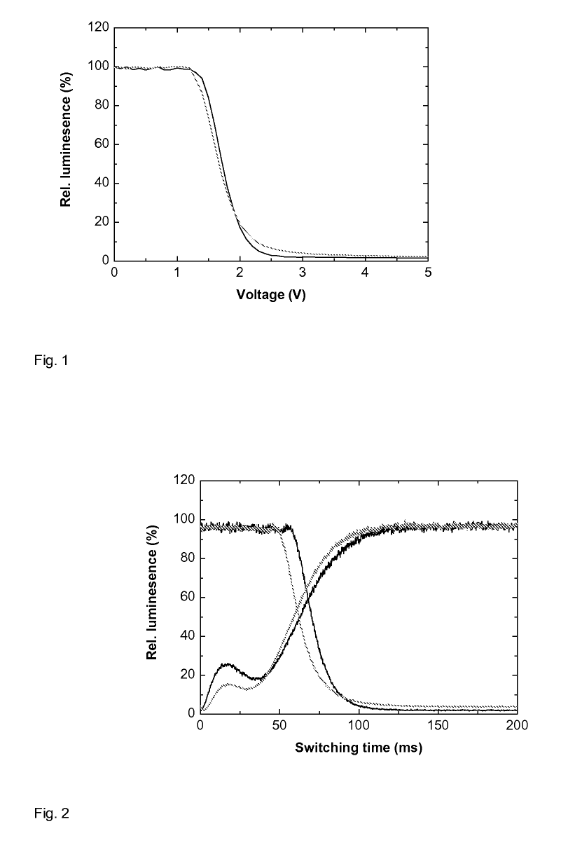

FIG. 1 shows a diagram displaying the measurement of the switching voltage of a twisted nematic cell with ITO electrodes (grey curve), and of such a cell with electrodes constructed by the process according to the invention (black curve).

FIG. 2 shows a diagram displaying the measurement of the switching speed (on and off) at a switching voltage of 3 V of the same cells as used for FIG. 1.

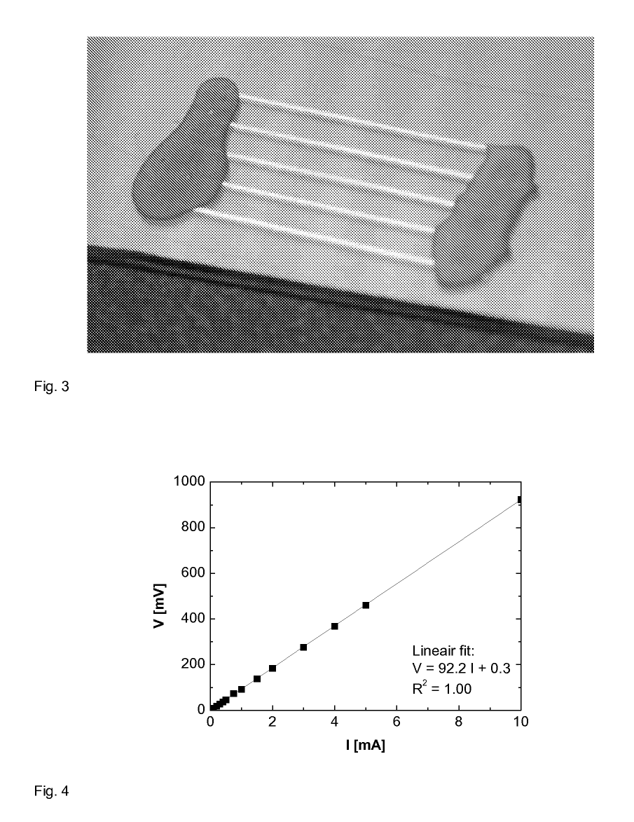

FIG. 3 is a photograph showing four tracks obtained by the process according to the invention.

FIG. 4 shows an I-V curve from a four-point probe measurement of a track obtained by the process according to the invention.

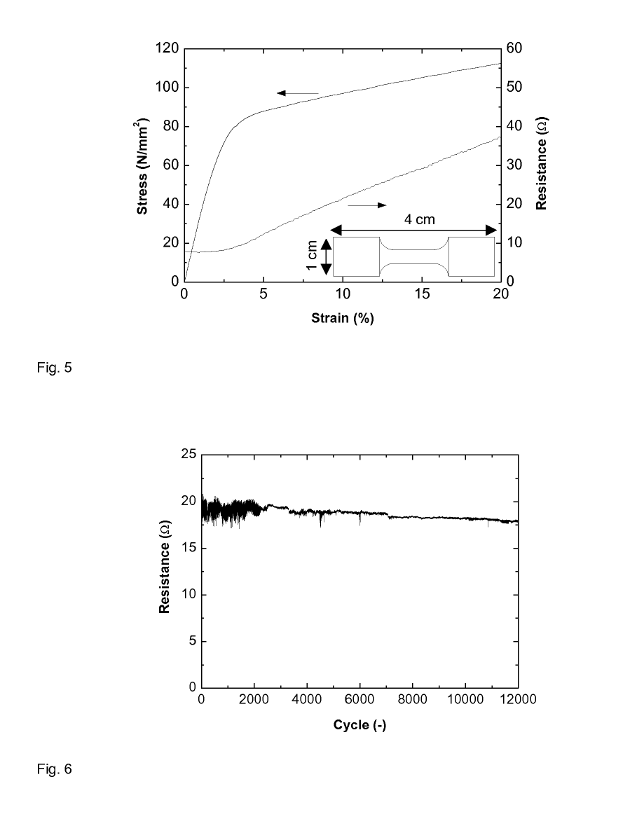

FIG. 5 shows a diagram displaying both the stress and resistance as a function of strain of a film comprising the conductive tracks according to the invention.

FIG. 6 shows a diagram displaying the resistance during cyclic loading of a 3×3 film comprising the conductive tracks according to the invention.

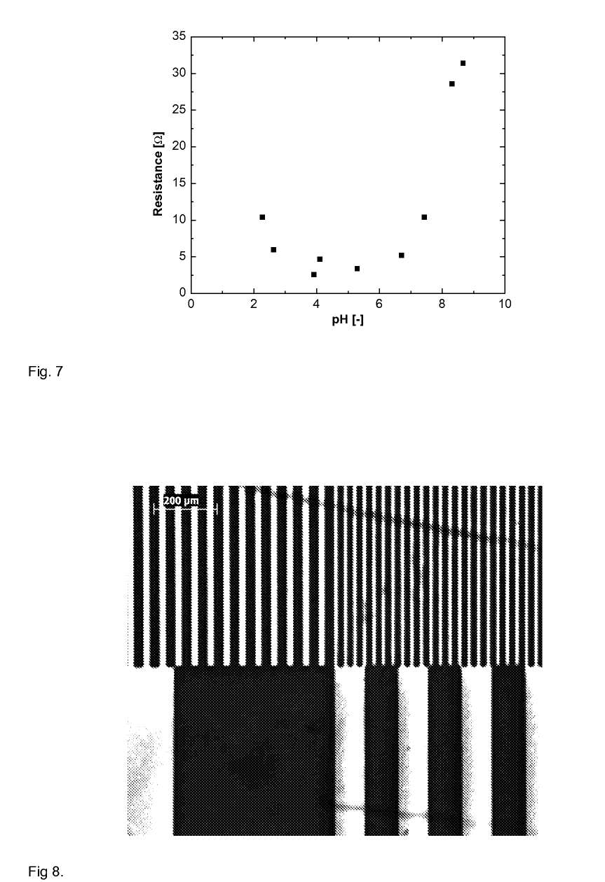

FIG. 7 shows a diagram displaying the resistance as a function of the pH of the reducing bath of a conductive track obtained by the process according to the invention.

FIG. 8 shows a microscope image of photolithographically obtained conductive tracks of varying sizes. The microscope image was taken in reflection.

### EXAMPLES

### Example 1

Silver neodecanoate was dissolved in toluene in a weight ratio of respectively 2:3. The solution was spun onto 3×3 cm borosilicate glass slides at 4000 rpm for 30 s. The obtained silver neodecanoate layer was then reduced by submerging the slides in a 1.6 wt % solution of hydroquinone in water for 5 minutes, after which they were washed with demineralised water followed by isopropanol. Finally, the slides were dried using compressed nitrogen. A polyimide precursor was spin coated on top of the electrodes, and cured at 180° C. for 120 minutes under vacuum. The polyimide was then uniaxially rubbed using a velvet cloth. UV curable glue containing 5 μm spacers was used to glue two substrates together, with the rubbing directions perpendicular to each other to create a TN LC cell. LC cells based on ITO electrodes were constructed with the same procedure. The cells were filled with a LC material, E7 (Merck), by capillary force, after which electrodes were attached with indium solder. The switching characteristics of the LC cells were measured using a DMS 703 Autronic (Melchers GmbH) in combination with a CCD-Spect-2 camera. FIGS. 1 and 2 show the results of these measurements. It can be seen, that the electrodes obtained by the process according to the invention exhibit the same switching characteristics as electrodes made of ITO.

### Example 2

Silver neodecanoate was dissolved in xylene in a weight ratio of respectively 2:3. The solution was applied in a line pattern via ink-jet printing to a 50-micron thick PET foil substrate. Next, the line pattern was exposed for 10 seconds to a UV light source (intensity 0.5 W/cm²) to activate the silver neodecanoate. In a final step, the pattern was reduced to a conductive track by dipping the PET foil containing the pattern for 15 seconds into a 10 wt % hydroquinone, 54 wt % ethanol and 36 wt % demineralized water solution. The complete process as described was performed at room temperature. FIG. 3 shows 4 tracks thus formed. The length of the tracks was 2 cm, the width was 200 μm and the height was 1 μm. The lines were connected by some silver paste. The resistance over all 4 lines was measured simultaneously, and was found to be 18Ω. The conductivity of a single track in S/m is calculated by dividing the length of the track (2 cm) by the resistance of the track over this distance (18Ω) and the cross-sectional area (4* 200 μm*1 μm=800 μm²) of the track. This is equal to:

σ(in S/m)=2*10⁻²/(18*800*10⁻¹²)=1.4*10⁶ S/m

### Example 3

Silver neodecanoate was dissolved in xylene in a weight ratio of respectively 1:2. The solution was applied in a line pattern via ink-jet printing to a borosilicate glass substrate. Next, the line pattern was exposed for 10 seconds to a UV light source (intensity 0.5 W/cm²) to activate the silver neodecanoate. In a final step, the pattern was reduced to a conductive track by dipping the substrate containing the pattern for 15 seconds into a 10 wt % hydroquinone, 54 wt % ethanol and 36 wt % demineralized water solution. The complete process as described was performed at room temperature. The resistance of one such printed track (length 1 cm, width 127 μm, height 131 nm) was measured using a four-point probe technique. The resulting I-V curve is shown in FIG. 4. The resistance was calculated to be 92.2Ω. From this value the conductivity was calculated to be 6.5*10⁶ S/m in a similar fashion as shown in example 2.

### Example 4

Silver neodecanoate was dissolved in toluene in a weight ratio of respectively 2:3. To this 0.6 wt % polystyrene (MW 3680 g/mol) was added and allowed to dissolve. The solution was applied via spin-coating (2000 rpm for 60 s) to a 50-micron thick PET foil substrate. Next, the obtained film of silver neodecanoate and the PET substrate were exposed for 10 seconds to a UV light source (intensity 0.5 W/cm²) to activate the silver neodecanoate. In a final step the exposed silver neodecanoate film was reduced into a conductive film by dipping the exposed film and the PET substrate for 15 seconds into a 10 wt % hydroquinone, 54 wt % ethanol and 36 wt % demineralized water solution. Here the conductive film was, as described in the invention, considered to be a conductive track. The process as described above was performed at room temperature.

The resistance of the obtained conductive film on top of the PET substrate was tested under mechanical loading. These tests were performed as described by Cairns and Crawford (Cairns, Crawford, Proceedings of the IEEE 2005, 93(8), 1451-1458). In FIG. 5 the effect on the resistance upon stretching up to 20% strain is shown. It was observed that the up to 5% strain there was no increase in the resistance. After 5% strain the resistance increased, however when the sample broke around 100% strain (which is not shown in the graph), the resistance was still only approximately 160Ω. The inset shows the geometry of the tested samples. The obtained conductive film on top of the PET substrate was also subjected to fatigue testing. Here the sample was rolled up onto a 3.75 cm diameter cylinder for 12,000 times. FIG. 6 shows that there was no change in resistance to be observed even after 12,000 cycles. Both FIGS. 5 and 6 show that the obtained conductive film on top of the PET substrate has very good mechanical properties.

### Example 5

Reducing solutions with varying pH (from 1.1 to 8.7) were prepared by adding the appropriate amounts of sulphuric acid or sodium hydroxide to solutions of 10 wt % hydroquinone, 54 wt % ethanol and 36 wt % demineralized water. Silver neodecanoate was dissolved in toluene in a weight ratio of respectively 2:3. The solution was applied via spin-coating (4000 rpm for 30 s) to 3×3 cm 50-micron thick PET foil substrates. Next, the obtained films of silver neodecanoate and the PET substrates were exposed for 10 seconds to a UV light source (intensity 0.5 W/cm²) to activate the silver neodecanoate. In a final step the exposed silver neodecanoate films were reduced into conductive films by dipping the exposed films and the PET substrates for 15 seconds into the prepared reducing solutions. The process as described above was performed at room temperature. FIG. 7 shows the conductivity of each film plotted against the pH of the reducing solutions. It can be seen that the ideal pH range for the reducing solution is 2.5 to 6.5. Below a pH value of 2.3 no conductivity could be measured.

### Example 6

Silver neodecanoate was dissolved in toluene in a weight ratio of respectively 2:3. A polyethylene fiber with a diameter of 1 mm was coated with silver neodecanoate by drawing the fiber through the solution. In a subsequent step the coated fiber was exposed for 100 seconds to a UV light source (intensity 0.05 W/cm²) to activate the silver neodecanoate. In the final step, the activated silver neodecanoate was reduced to a conductive track by drawing the fiber in 15 seconds through a solution of 10 wt % hydroquinone, 54 wt % ethanol and 36 wt % demineralized water. The complete process as described was performed at room temperature. The created conductive fiber had a resistance of about 3 Ωcm⁻¹.

### Example 7

Silver neodecanoate was dissolved in toluene in a weight ratio of respectively 2:3. The solution was spincoated on a borosilicate glass substrate. In a subsequent step the coated substrate was exposed for 100 seconds to a UV light source (intensity 0.05 W/cm²) to activate the silver neodecanoate. In the final step, the activated silver neodecanoate was reduced to a conductive track by drawing the fiber in 15 seconds through a solution 10 wt % ascorbic acid, 54 wt % ethanol and 36 wt % demineralized water. The complete process as described was performed at room temperature.

### Example 8

Silver neodecanoate was dissolved in toluene in a weight ratio of respectively 2:3. The solution was spincoated on a borosilicate glass substrate. In a subsequent step the coated substrate was exposed for 100 seconds to a UV light source (intensity 0.05 W/cm²) to activate the silver neodecanoate. In the final step, the activated silver neodecanoate was reduced to a conductive track by drawing the fiber in 15 seconds through a solution 10 wt % pyrocatechol, 54 wt % ethanol and 36 wt % demineralized water. The complete process as described was performed at room temperature.

### Example 9

Silver neodecanoate was dissolved in toluene in a weight ratio of respectively 2:3. This solution was spincoated at 3000 rpm on top of a borosilicate glass substrate. The obtained solid film was subsequently exposed through a photolithographic line mask (0.5 mm periodicity, fill factor 0.5) to a UV light source for 120 seconds (intensity 0.05 W/cm²) to locally activate the silver neodecanoate. After the patterned exposure step, the silver neodecanoate film was dipped for 15 seconds into a solution containing 10 wt % hydroquinone, 54 wt % ethanol and 36 wt % demineralized water. During this step the exposed areas were sufficiently fast reduced into conductive silver tracks, while the non-exposed areas remained unconductive and could still be removed by rinsing the entire film with isopropanol. The complete process as described was performed at room temperature. The resistance of one such photolithographically obtained tracks (length 1 cm, width 250 μm, height 200 nm) was determined to be approximately 47Ω.

1. A process for manufacturing conductive tracks comprising a coating step, in which an organometallic compound is applied from a solution onto a substrate; and a reducing step, characterized in that the reducing step is carried out by means of an acidic solution containing a reducing agent.

2. The process according to claim 1, wherein after application of the organometallic compound onto a substrate, but before the reducing step, said organometallic compound is activated by exposure to electromagnetic radiation.

3. The process according to claim 2, wherein only a part of the organometallic compound is activated via locally exposing said compound to electromagnetic radiation.

4. The process according to claim 1, wherein the manufacturing is carried out at a temperature range between 0°0 and 70° C.

5. The process according to claim 1, wherein the organometallic compound is a metal carboxylate.

6. The process according to claim 1, wherein the organometallic compound is a metal thiolate.

7. The process according to claim 1, wherein the organometallic compound is silver neodecanoate.

8. The process according to claim 1, wherein the organometallic compound is dissolved into an apolar solvent.

9. The process according to claim 1, wherein the substrate is polymeric.

10. The process according to claim 9, wherein the substrate comprises at least 80% of polyethylene terephthalate).

11. The process according to claim 9, wherein the substrate comprises at least 80% of triacetyl cellulose.

12. The process according to claim 1, wherein the substrate has any shape and size, such as a sheet or a fiber.

13. The process according to claim 1, wherein the source for the electromagnetic radiation is light in a wavelength range between 200-1000 nm.

14. The process according to claim 13, wherein the source for the electromagnetic radiation is light in a wavelength range between 250-450 nm.

15. The process according to claim 1, wherein the reducing agent in the reducing solution is a phenolic compound or a derivative thereof, ascorbic acid, formic acid or boric acid, either alone or in combination.

16. The process according to claim 15, wherein the reducing agent is hydroquinone or a derivative thereof.

17. The process according to claim 1, wherein the reducing agent is dissolved in a combination of water and an alcohol.

18. The process according to claim 1, wherein a solid organic compound is added to the solution containing the organometallic compound.

19. The process according to claim 18, wherein said solid organic compound is polymeric or oligomeric or monomeric.

20. The process according to claim 18, wherein said solid organic compound is a mixture of the monomeric compound and a polymerization initiator.

21. The process according to claim 20, wherein said polymerization initiator is a UV initiator.

22. The process according to claim 4 wherein the temperature ranges between 15° C. and 40° C.
